(19) United States
(12) Patent Application Publication
(10) Pub. No.: US 2023/0311659 A1
(43) Pub. Date: Oct. 5, 2023

(54) SAFETY ASSIST DEVICE

(71) Applicant: HONDA MOTOR CO., LTD., Tokyo (JP)

(72) Inventors: Yuichiro SHIMURA, Saitama (JP); Junichi SAKAMOTO, Saitam (JP); Masaki MARUYAMA, Saitama (JP); Toru EZAKI, Saitama (JP)

(21) Appl. No.: 18/183,964

(22) Filed: Mar. 15, 2023

(30) Foreign Application Priority Data
Mar. 30, 2022 (JP) 2022-057148

(51) Int. Cl. B60K 35/00

(52) U.S. Cl. CPC B60K 35/00; B60K 2370/149; B60K 2370/152; B60K 2370/178; B60K 2370/179; B60K 2370/785; B60K 2370/73

(57) ABSTRACT

A safety assist device includes an object detection camera and a radar that detect the presence of an object and a position of the object on a lateral side or a rear side of an own vehicle, a vehicle speed sensor that detects a vehicle speed of the own vehicle, a driver's seat-side display and a passenger's seat-side display that are provided on a lateral side of a driver's seat inside the own vehicle, and a controller that causes the driver's seat-side display and the passenger's seat-side display to display a signal in response to the presence of the object detected by the object detection camera, the radar, and the like. The controller moves a position at which the signal is displayed toward a front side in a display range of the driver's seat-side display and the passenger's seat-side display in accordance with an increase in the vehicle speed detected.

This application is based on and claims the benefit of priority from Japanese Patent Application 2022-057148, filed on 30 Mar. 2022, the content of which is incorporated herein by reference.

### BACKGROUND OF THE INVENTION

### Field of the Invention

The present invention relates to a safety assist device for a vehicle.

### Related Art

In recent years, efforts have been actively made to provide accesses to sustainable transportation systems that consider people in weak positions among traffic participants. To realize the sustainable transportation, study and development to further improve traffic safety and convenience through study and development on preventive safety technology have been advanced.

Regarding the above preventive safety technology, there is known a safety assist device for a vehicle that visually alerts, using a display, a driver to presence of objects that are likely to cause risks of collision (see, for example, Japanese Unexamined Patent Application, Publication No. 2010-264952). According to Japanese Unexamined Patent Application, Publication No. 2010-264952, to alert the driver of an own vehicle to the presence of a vehicle that is approaching the own vehicle from a lateral side or from diagonal rear and that does not come into the visual field of the driver, a plurality of light emitting elements are provided to a door lining part and are flashed in order in a front-to-rear direction so as to guide a driver's sight line to the blind spot.
Patent Document 1: Japanese Unexamined Patent Application, Publication No. 2010-264952

### SUMMARY OF THE INVENTION

The technique disclosed in Japanese Unexamined Patent Application, Publication No. 2010-264952 can alert a driver to the presence of an approaching object not only at a time of left or right turn, but also at a time of normal driving such as driving straight ahead, and is useful as the safety assist device. However, the technique mainly assumes a call for attention at a time of left or right turn, and therefore there is a room for improvement in that when the own vehicle travels at a high speed, the driver's visual field is narrowed and it becomes difficult for the driver to perceive the presence of an object.

An object of the present invention is to provide a safety assist device that can visually perceivably alert a driver to presence of an object such as a vehicle approaching the driver's vehicle from a lateral side or from rear even in case where a vehicle speed is fast and the driver's visual field is narrowed.
(1) One aspect of the present invention is directed to a safety assist device (e.g., a safety assist device 1 described later) for a vehicle. The safety assist device includes: an object detector (e.g., an object detection camera 21, a radar 22, or both described later) that detects at least presence of an object (e.g., an object 150 described later) and a position of the object on a lateral side or a rear side of an own vehicle (e.g., an own vehicle 100 described later); a vehicle speed detector (e.g., a vehicle speed sensor 23 described later) that detects a vehicle speed of the own vehicle; a display (e.g., a driver's seat-side display 31 and a passenger's seat-side display 32 described later) that is provided at least on a lateral side of a driver's seat (e.g., a driver's seat 91 described later) inside the own vehicle; and a controller (e.g., a controller 10 described later) that causes the display to display a signal in response to the presence of the object detected by the object detector. The controller moves a position at which the signal is displayed toward a front side in a display range of the display in accordance with an increase in the vehicle speed detected by the vehicle speed detector.

Consequently, even when the own vehicle travels at a high speed at which a driver's visual field tends to be narrowed, an indication of the presence of the object is displayed on a front side that readily comes into the driver's view according to the vehicle speed, whereby it is possible to perceivably alert the driver to the presence of the object.
(2) In the safety assist device according to (1), a driver's seat-side display (e.g., the driver's seat-side display 31 described later) disposed on a side of the driver's seat and a passenger's seat-side display (e.g., the passenger's seat-side display 32 described later) disposed on a side of a passenger's seat (e.g., a passenger's seat 92 described later) may be provided as the display, and one of the driver's seat-side display and the passenger's seat-side display that corresponds to a direction in which the object is present in a vehicle width direction with respect to the own vehicle may be caused to display the signal.

Consequently, one of the driver's seat-side display and the passenger's seat-side display corresponding to the position of the object displays the signal, whereby it is possible to make the driver intuitively recognize the presence of the object somewhere in a vehicle width direction.
(3) In the safety assist device according to (2), the signal may be displayed such that in a case where the own vehicle is traveling at a predetermined vehicle speed, an angle formed between a direction of a sight line of a driver seeing a position on the driver's seat-side display at which the signal is displayable and a direction of a sight line of the driver facing a front is substantially equal to an angle formed between a direction of a sight line of the driver seeing a position on the passenger's seat-side display at which the signal is displayable and the direction of the sight line of the driver facing the front.

Consequently, both of the driver's seat-side display and the passenger's seat-side display can make the signal come into the driver's visual field range, whereby it is possible to further enhance visibility.
(4) In the safety assist device according to any one of (1) to (3), the object detector may further detect a relative distance between the own vehicle and the object, and the controller may change an intensity of the signal according to the relative distance.

Consequently, the driver can grasp not only a risk of collision against an object, but also a level of the risk.
(5) In the safety assist device according to (4), the intensity may be an area of the signal, a luminance of the signal, a chroma of the signal, a brightness of the signal, a flashing cycle of the signal, or a combination thereof.

Consequently, it is possible to make the driver more intuitively recognize the level of the risk.
(6) In the safety assist device according to (5), the object detector may further detect relative positions of the own vehicle and the object, and the position at which the signal is displayed may change according to the relative positions.

Consequently, it is also possible to recognize the position of the object, based on a change in the display position of the signal. Furthermore, it is possible to recognize the relative distance based on the intensity of the signal, and consequently it is possible to distinguish whether the object has approached and the position of the signal has changed, or the vehicle speed of the own vehicle has increased and the position of the signal has changed.
(7) In the safety assist device according to any one of (1) to (6), the display may be provided on an outer side of a door glass (e.g., a door glass 111 described later) of a front door (e.g., a front door 110 described later).

Consequently, it is possible to display the signal at the position at which the driver easily perceives the signal.
(8) In the safety assist device according to any one of (1) to (7), the display may be provided to the door glass (e.g., the door glass 111 described later) of the front door (e.g., the front door 110 described later).

Consequently, it is possible to check the signal in a peripheral visual field area where sight line movement is little, and make the driver more perceivably recognize the presence of the object.
(9) The safety assist device according to any one of (1) to (8) may further include a sight line monitor (e.g., a monitor camera 24 described later) that monitors a sight line of a driver, and the controller may lower an intensity of the signal upon determining, based on detection information from the sight line monitor, that the driver has visually recognized the object.

Consequently, it is not necessary to indicate the presence of the object to the driver when the driver has recognized the object, thereby preventing a less necessary signal for the driver from being displayed and reducing annoyance.

The present invention can provide a safety assist device that can visually perceivably alert a driver to presence of an object such as a vehicle approaching the driver's vehicle from a lateral side or from rear even in case where a vehicle speed is fast and the driver's visual field is narrowed. Furthermore, the present invention can eventually contribute to development of a sustainable transportation system.

### BRIEF DESCRIPTION OF THE DRAWINGS

FIG. 1 is a block diagram illustrating a configuration of a safety assist device according to an embodiment of the present invention;

FIG. 2 is a view illustrating a front door on which a driver's seat-side display of the safety assist device according to the embodiment is disposed, as seen from a vehicle interior;

FIG. 3 is a block diagram illustrating an example of a hardware configuration of a controller of the safety assist device according to the embodiment;

FIG. 4 is a view illustrating a relationship between a display position at which information indicating an object is displayed and a driver's visual field range that changes depending on a vehicle speed, according to the safety assist device of the embodiment;

FIG. 5A is a view for illustrating an example in which an indication of presence of an object is displayed on the driver's seat-side display of the safety assist device according to the embodiment;

FIG. 5B is a view for illustrating an example in which an indication of presence of an object is displayed on a passenger's seat-side display of the safety assist device according to the embodiment;

FIG. 5C is a view for illustrating an example in which an indication of the presence of the object is displayed on the passenger's seat-side display of the safety assist device according to the embodiment;

FIG. 6A is a view for illustrating an example in which the driver's seat-side display of the safety assist device according to the embodiment performs highlighting;

FIG. 6B is a view for illustrating an example in which display of the driver's seat-side display of the safety assist device according to the embodiment is stopped based on driver's recognition;

FIG. 7 is a view for illustrating an example in which a symbol is changed according to an alert level of the safety assist device according to the embodiment;

FIG. 8 is a view for illustrating an example in which a silhouette shape is changed according to an alert level of the safety assist device according to the embodiment;

FIG. 9 is a view for illustrating fade-in processing and fade-out processing of the safety assist device according to the embodiment;

FIG. 10 is a flowchart illustrating a flow of alert processing of the safety assist device according to the embodiment;

FIG. 11 is a view illustrating a relationship between a display position at which information indicating an object is displayed and a driver's visual field range that changes depending on a vehicle speed, according to a safety assist device of a modification; and

FIG. 12 is a view for illustrating an example in which an indication of presence of an object is displayed on a passenger's seat-side display of the safety assist device according to the modification.

### DETAILED DESCRIPTION OF THE INVENTION

An embodiment of the present invention will be described below with reference to the drawings.

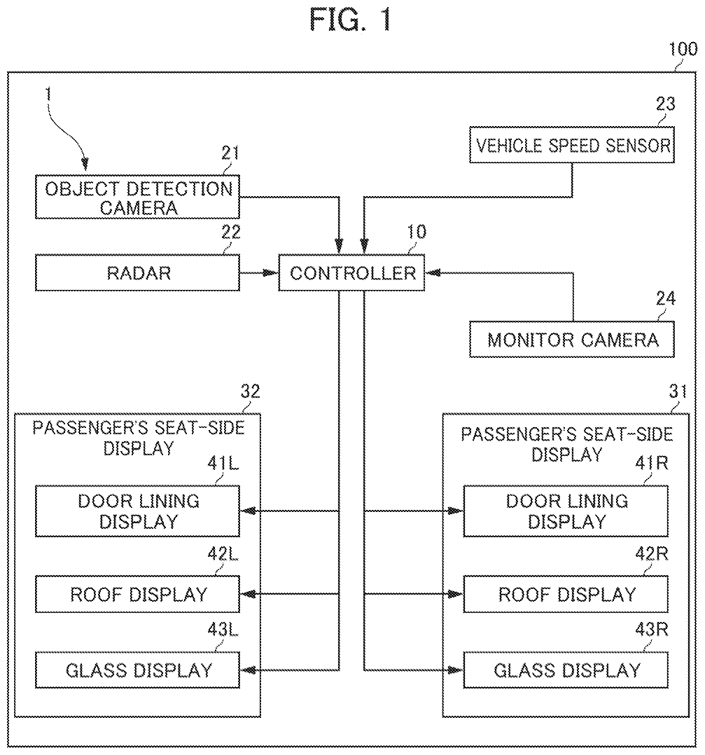

FIG. 1 is a block diagram illustrating a configuration of a safety assist device 1 according to the embodiment of the present invention. The safety assist device 1 is a system that is mounted on an own vehicle 100, and alerts a driver to a risk of collision. The safety assist device 1 includes an object detection camera 21, a radar 22, a vehicle speed sensor 23, a monitor camera 24, a driver's seat-side display 31, a passenger's seat-side display 32, and a controller 10.

The object detection camera 21 is an object detector that detects an object outside the own vehicle 100 by capturing images outside the own vehicle 100. The images obtained by the object detection camera 21 are analyzed to obtain detection information such as a relative position of the object outside the own vehicle 100, a relative distance between the object and the own vehicle 100, a speed, and an azimuth.

The radar 22 is an object detector that transmits an electromagnetic wave, receives a reflected wave of this electromagnetic wave, and detects the object outside the own vehicle 100. A received signal of the electromagnetic wave obtained by the radar 22 is analyzed to obtain detection information such as a relative position of the object outside the own vehicle 100, a relative distance between the object and the own vehicle 100, a speed, and an azimuth.

The detection information of the object obtained by the object detection camera 21 and the detection information of the object obtained by the radar 22 are transmitted to the controller 10. Note that the object outside the own vehicle 100 may be detected by the object detection camera 21 alone or by the radar 22 alone.

The vehicle speed sensor 23 is a vehicle detector that detects a speed of the own vehicle 100. The vehicle speed sensor 23 may calculate the speed of the own vehicle 100 based on information related to a driving system such as a rotational speed of an engine, a gear ratio, and a rotational speed of a motor, or may obtain the speed of the own vehicle 100 via an Electronic Control Unit (ECU) that controls the driving system.

The monitor camera 24 is a sight line monitor that monitors a driver's sight line direction. The monitor camera 24 is disposed at a position at which the monitor camera 24 can identify the driver's sight line direction. The monitor camera 24 is disposed at, for example, a diagonally front right side of the driver.

The driver's seat-side display 31 is a display that is disposed on the driver side to alert the driver to the presence of the object. The driver's seat-side display 31 according to the present embodiment includes a door lining display 41R, a roof display 42R, and a glass display 43R.

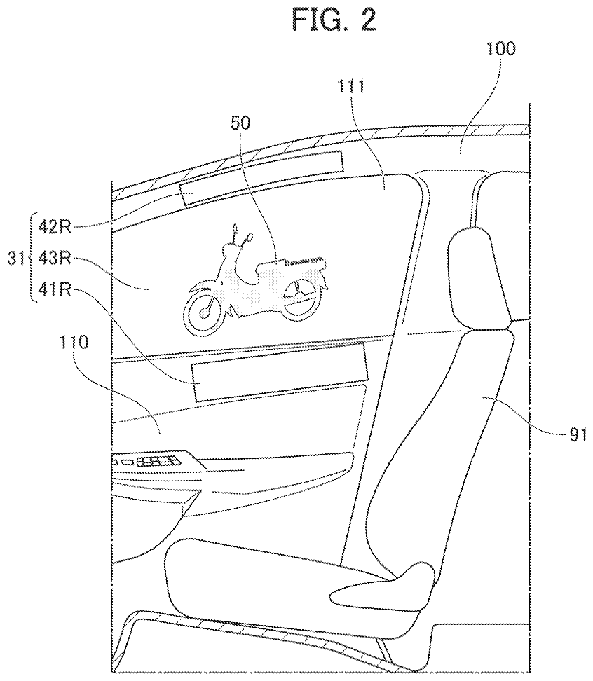

FIG. 2 is a view illustrating a front door 110 on which the driver's seat-side display 31 of the safety assist device 1 according to the present embodiment is disposed, as seen from a vehicle interior.

The door lining display 41R is disposed below a door glass 111 of the front door 110. The door lining display 41R is a line type light emission device whose display range extends in a front/rear direction, and a signal for alerting the driver to the presence of the object is light emission at a predetermined display position. The door lining display 41R can change the display position (light emission position) in the front/rear direction. Furthermore, the door lining display 41R can visually alert the driver to the presence of the object in various display modes by combining or changing an area, a luminance, a chroma, a luminance, a flashing cycle, and the like of a light emission part.

The roof display 42R is disposed above the door glass 111 of the front door 110. The roof display 42R is a line type light emission device whose display range extends in the front/rear direction, and a signal for alerting the driver to the presence of the object is light emission at a predetermined display position. The roof display 42R can change the display position (light emission position) in the front/rear direction. The roof display 42R can change a light emission position in the front/rear direction. Furthermore, the roof display 42R can visually alert the driver to the presence of the object in various display modes by combining or changing an area, a luminance, a chroma, a luminance, a flashing cycle, and the like of a light emission part.

The glass display 43R is configured to be able to display image information as a signal that indicates the presence of the object. The glass display 43R includes a self-luminous interlayer buried in the door glass 111, a projector whose illustration is omitted, and the like. In FIG. 2, a two-wheeled vehicle is detected as an object for which an alert needs to be raised, and a silhouette 50 corresponding to the two-wheeled vehicle is displayed as a signal on the glass display 43R. The glass display 43R can also display a figure such as a symbol, a character, and a combination thereof, in addition to the silhouette 50 corresponding to a shape of an object. Furthermore, the glass display 43R can realize various display modes by combining an area, a brightness, a chroma, a luminance, a flashing cycle, and the like of a display object to be displayed.

The passenger's seat-side display 32 is a display that is disposed on a passenger's side for alerting the driver to the presence of the object. The passenger's seat-side display 32 according to the present embodiment includes a door lining display 41L, a roof display 42L, and a glass display 43R. The door lining display 41L employs the same configuration as that of the door lining display 41R, the roof display 42L also employs the same configuration as that of the roof display 42R, and the glass display 43L also employs the same configuration as that of the glass display 43R.

The controller 10 is a computer that controls the safety assist device 1. The controller 10 is communicably connected with electronic devices such as the object detection camera 21, the radar 22, the driver's seat-side display 31, and the passenger's seat-side display 32. Note that the controller 10 may be directly connected to the electronic devices, or may be connected to the electronic devices via an Electric Control Unit (ECU) that integrally controls other systems, and the controller 10 itself may be the ECU.

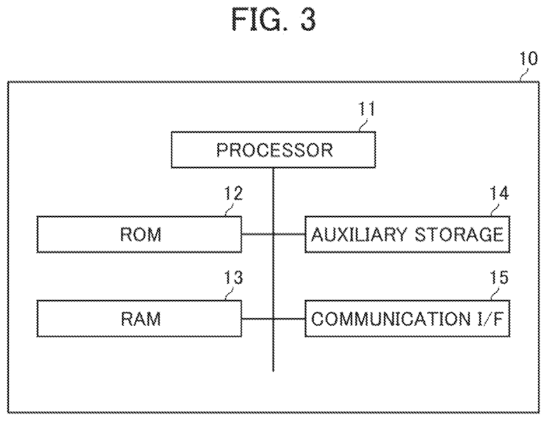

FIG. 3 is a block diagram illustrating an example of a hardware configuration of the controller 10 of the safety assist device 1 according to the present embodiment. Note that the hardware configuration of the controller 10 described below with reference to FIG. 3 below is merely an example, and is not limited to this configuration.

The controller 10 is a computer that includes a processor 11, a Read-Only Memory (ROM) 12, a Random-Access Memory (RAN) 13, an auxiliary storage 14, and a communication Interface (I/F) 15, and in which each unit is connected by buses or the like.

The processor 11 is a center part of the computer that performs arithmetic operations necessary for operations of the safety assist device 1, and processing such as control, and performs various arithmetic operations, processing, and the like. The processor 11 is, for example, a Central Processing Unit (CPU), a Micro Processing Unit (MPU), a System On a Chip (SoC), a Digital Signal Processor (DSP), a Graphics Processing Unit (GPU), an Application Specific Integrated Circuit (ASIC), a Programmable Logic Device (PLD), or a Field-Programmable Gate Array (FPGA). Alternatively, the processor 11 is a combination of a plurality of these processors. Furthermore, the processor 11 may be formed by combining a hardware accelerator or the like with these processors.

The processor 11 controls each unit to realize various functions of the safety assist device 1 based on programs such as firmware, system software, application software, and the like stored in the ROM 12, the auxiliary storage 14, and the like. Furthermore, the processor 11 executes processing described later based on the programs. Note that part or all of the programs may be implemented in circuits of the processor 11.

The ROM 12 and the RAM 13 are main storages of the computer whose center part is the processor 11. The ROM 12 is a non-volatile memory that is mainly used to read data. The ROM 12 stores, for example, firmware or the like among the above programs. Furthermore, the ROM 12 stores, for example, data used by the processor 11 to perform various processing. The RAM 13 is a memory used to read and write data. The RAM 13 is used as a working area that stores data temporarily used by the processor 11 to perform various processing. The RAM 13 is typically a volatile memory.

The auxiliary storage 14 is, for example, an Electric Erasable Programmable Read-Only Memory (EEPROM), a Hard Disk Drive (HDD), a flash memory, or the like. The auxiliary storage 14 stores, for example, the system software and the application software among the above programs. Furthermore, the auxiliary storage 14 stores data used by the processor 11 to perform various processing, data generated by processing of the processor 11, various setting values, and the like.

The communication I/F 15 is an interface for communicating with external electronic devices. The controller 10 obtains various pieces of detection information from the object detection camera 21, the radar 22, and the vehicle speed sensor 23 via the communication I/F 15, and controls each of the driver's seat-side display 31 and the passenger's seat-side display 32.

Next, alert processing of the safety assist device 1 realized by the controller 10 will be described. When obtaining from the object detection camera 21, the radar 22, and the like the detection information indicating an object 150 which is present on a lateral side or a rear side of the own vehicle 100 and for which an alert needs to be raised, the controller 10 according to the present embodiment executes the alert processing of controlling the driver's seat-side display 31 and the passenger's seat-side display 32 located on the lateral side of a driver 101. According to the alert processing, the controller 10 performs display control on the driver's seat-side display 31 and the passenger's seat-side display 32 based on a vehicle speed that is a speed of the own vehicle 100 and a positional relationship between the own vehicle 100 and the object 150.

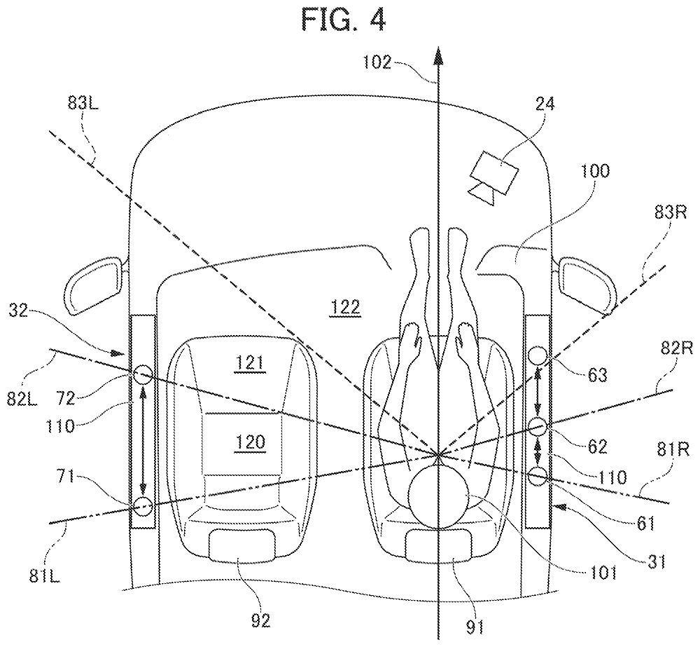

A relationship between the vehicle speed of the own vehicle 100 and a display position will be described first. FIG. 4 is a view illustrating a relationship between the display position at which an indication of a position of an object is displayed and a visual field range of the driver 101 that changes depending on the vehicle speed, according to the safety assist device 1 of the present embodiment. Note that a display position of the driver's seat-side display 31 corresponds to a display position of each of the door lining display 41R, the roof display 42R, and the glass display 43R in the following description. Furthermore, a display position of the passenger's seat-side display 32 corresponds to a display position of each of the door lining display 41L, the roof display 42L, and the glass display 43L.

As illustrated in FIG. 4, a driver's seat 91 and a passenger's seat 92 are aligned in a vehicle width direction, the driver's seat-side display 31 is located on a right side in the vehicle width direction of the driver's seat 91, and the passenger's seat-side display 32 is located on a left side in the vehicle width direction of the driver's seat 91. According to this configuration, visual field ranges 120 to 122 of the driver 101 change according to a vehicle speed. The visual field range 122 indicated on a front side of the driver 101 by a broken line is the fastest speed range, the visual field range 121 indicated by a dashed-dotted line is a middle vehicle speed range, and the visual field range 120 indicated by a dashed-two dotted line is a low vehicle speed range. As illustrated in FIG. 4, the visual field range 122<the visual field range 121<the visual field range 120 holds, and, as the vehicle speed is faster, the visual field range becomes narrower.

Hence, the controller 10 according to the present embodiment performs control of adjusting the position at which an indication is displayed to alert the driver to a position of an object according to a vehicle speed. The display position does not indicate one point, but indicates a reference position for performing display. For example, a signal indicating the presence of an object in an area on a front side of the display position is displayed with the display position serving as the position reference.

In the example in FIG. 4, the display position of the driver's seat-side display 31 is set on a virtual straight line inclined at a predetermined angle (+α) rightward from a front sight line direction 102 that is a visual field center of the driver 101 facing the front side in plan view and that serves as 0 degree of a reference angle. When, for example, the vehicle speed of the own vehicle 100 is in a low-speed range of approximately 40 km/h, the controller 10 sets to a display position 61 a position of +100 degrees from the front sight line direction 102 to correspond to the visual field range 120. Similarly, when the vehicle speed of the own vehicle 100 is in a middle speed range of approximately 70 km/h, the controller 10 sets to a display position 62 a position of +75 degrees from the front sight line direction 102, and, when the vehicle speed is in a high-speed range of approximately 100 km/h, the controller 10 sets to a display position 63 a position of +40 degrees from the front sight line direction 102.

The display position of the passenger's seat-side display 32 is set on a virtual straight line inclined at a predetermined angle (angle-α) leftward from the front sight line direction 102 that serves as 0 degree of the reference angle. The driver's seat-side display 31 and the passenger's seat-side display 32 are at different distances in the vehicle width direction from the driver 101, and are at different positions in the front/rear direction even when absolute values of the angles α are the same. Although, when, for example, the vehicle speed of the own vehicle 100 is in the low-speed range of approximately 40 km/h, the controller 10 sets to a display position 71 a position of −100 degrees from the front sight line direction 102, the display position 71 is located on the rear side of the display position 61. Furthermore, although, when the vehicle speed is in the middle speed range of approximately 70 km/h, the controller 10 sets to a display position 72 a position of −75 degrees from the front sight line direction 102, this display position 72 is on the front side of the display position 62. On the other hand, when the vehicle speed is in the high-speed range of approximately 100 km/h, if the controller 10 sets a display position to a position of −40 degrees from the front sight line direction 102, the display position goes out of a display range of the passenger's seat-side display 32, and therefore is set to the same position as that of the display position 72 or on the front side of the display position 72.

In the above example, an angle formed between a front right side sight line direction 81R that views the display position 61 with the position of the driver 101 serving as the position reference, and the front sight line direction 102 is 100 degrees, and an angle formed between a front left side sight line direction 81L that views the display position 71 with the position of the driver 101 serving as the position reference, and the front sight line direction 102 is 100 degrees. An angle formed between a front right side sight line direction 82R that views the display position 62 with the position of the driver 101 serving as the position reference, and the front sight line direction 102 is 75 degrees, and an angle formed between a front left side sight line direction 82L that views the display position 72 with the position of the driver 101 serving as the position reference, and the front sight line direction 102 is 75 degrees.

Furthermore, the controller 10 can perform processing of dynamically changing the display position according to a relative positional relationship between the own vehicle 100 and an object. For example, the controller 10 changes the display position in response to a change in the relative positional relationship with the object as indicated by arrows in the driver's seat-side display 31 and the passenger's seat-side display 32 in FIG. 4. In this example, when the object approaches the own vehicle 100 at the low-speed range, the display position 61 is moved to the display position 62, and, when the object further approaches the own vehicle 100, the display position 62 is further moved to the display position 63. Similarly, when the object moves away from the own vehicle 100 at the low-speed range, the display position 63 is moved to the display position 62, and, when the object further moves away from the own vehicle 100, the display position 62 is moved to the display position 61. The passenger's seat-side display 32 also changes an interval between the display position 71 and the display position 72 according to the positional relationship between the own vehicle 100 and the object as indicated by the arrow.

Note that the display position is preferably moved within a range that falls in the visual field ranges 120 to 122 corresponding to the vehicle speed of the own vehicle 100. For example, display is moved in an area on the front side of the display position 61 and the display position 71 in a case of the low-speed range, display is moved in an area on the front side of the display position 62 and the display position 72 in a case of the middle speed range, and display is moved in an area on the front side of the display position 63 and the display position 72 in a case of the high-speed range.

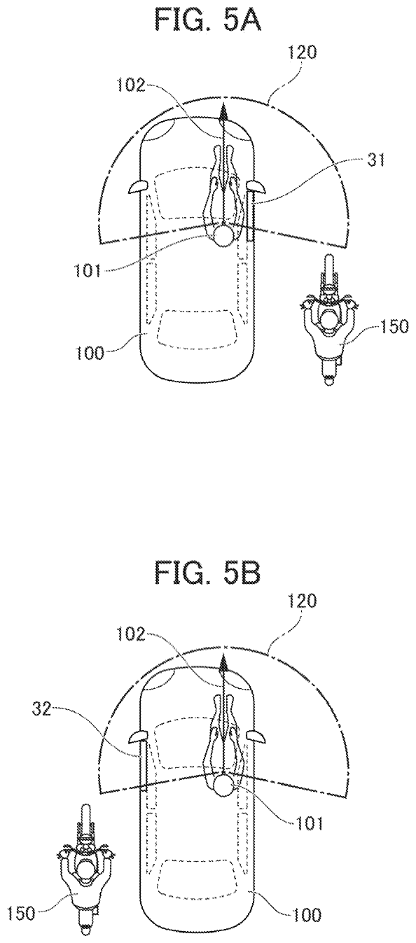

Next, a positional relationship between the own vehicle 100 and the object 150 will be described with reference to FIGS. 5A to 5C. FIGS. 5A to 5C illustrate the positional relationship between the own vehicle 100 and the object 150 in plan view. FIGS. 5A to 5C illustrate the visual field range 120 of the driver 101 in a relatively low speed range of approximately 40 km/h, and the front sight line direction 102 of the driver 101 is indicated by an arrow. In the following description, a case where at least one of the door lining display 41R, the roof display 42R, and the glass display 43R displays a signal is described as “the driver's seat-side display 31 displays a signal”. Similarly, a case where at least one of the door lining display 41L, the roof display 42L, and the glass display 43L displays a signal is described as “the passenger's seat-side display 32 displays a signal”.

FIG. 5A is a view for illustrating an example in which an indication of the presence of the object 150 is displayed on the driver's seat-side display 31 of the safety assist device 1 according to the present embodiment. When the object 150 is present at a rear right side seen from the driver 101 as illustrated in FIG. 5A, the object is outside the visual field range 120, and therefore it is necessary to alert the driver 101 to the presence of the object 150. When detecting the object 150 on the right side of the driver 101 based on the detection information from the object detection camera 21 and the radar 22, the controller 10 selects, from the driver's seat-side display 31 and the passenger's seat-side display 32, the driver's seat-side display 31 that corresponds to the direction in which the object 150 is present and causes the driver's seat side display 31 to display an indication of the presence of the object 150.

Both FIGS. 5B and 5C are views for illustrating examples in which an indication of the presence of the object 150 is displayed on the passenger's seat-side display 32 of the safety assist device 1 according to the present embodiment. In both examples illustrated in FIGS. 5B and 5C, the object 150 is located on the left side seen from the driver 101. The object 150 in FIG. 5C is located rearward in comparison with the object 150 in FIG. 5B. In both examples illustrated in FIGS. 5B and 5C, when detecting the object 150 on the left side of the driver 101 based on the detection information from the object detection camera 21 and the radar 22, the controller 10 selects, from the driver's seat-side display 31 and the passenger's seat-side display 32, the passenger's seat-side display 32 that corresponds to the direction in which the object 150 is present and causes the passenger's seat-side display 32 to display an indication of the presence of the object 150. As described above, when the object 150 moves between the positions illustrated in FIGS. 5B and 5C, a display position may be changed within a range on the front side of the display position 61 to meet a movement direction of the object 150.

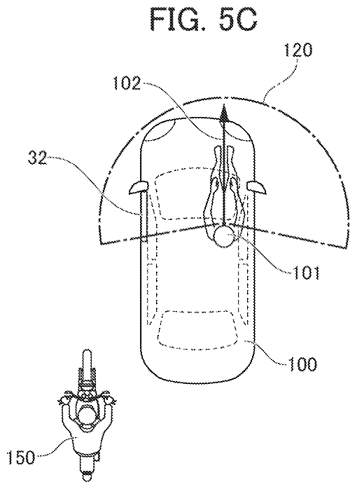

Next, a relationship between a recognition level of the driver 101 and display indicating the presence of the object 150 will be described with reference to FIGS. 6A and 6B. FIG. 6A is a view illustrating an example in which the driver's seat-side display 31 of the safety assist device 1 according to the present embodiment performs highlighting. FIG. 6A illustrates a state in plan view where, even though the position of the object 150 comes into the visual field range 120 of the driver 101, the driver 101 does not recognize the presence of the object 150.

The controller 10 highlights a call for more attention to the driver 101 than that of normal display when the the object 150 is at a position to which the driver 101 needs to be strongly alerted, and the driver 101 does not recognize the object 150. A mode of this highlighting will be described later.

The position of the object 150 to which the driver 101 needs to be strongly alerted is detected based on, for example, the detection information of the object detection camera 21 and the radar 22. Furthermore, whether or not the driver 101 recognizes the object 150 is determined by analyzing an image obtained by the monitor camera 24. For example, the controller 10 determines that the driver 101 does not recognize the object 150 when the front sight line direction 102 of the driver 101 does not cross the object 150, and faces the front side.

FIG. 6B is a view for illustrating an example in which display of the driver's seat-side display 31 of the safety assist device 1 according to the present embodiment is stopped based on recognition of the driver 101. As illustrated in FIG. 6B, the controller 10 stops the display of the driver's seat-side display 31 when determining that the driver 101 has recognized the object 150. For example, the controller 10 determines that the driver 101 does not recognize the object 150 when the front sight line direction 102 of the driver 101 crosses the object 150.

Although control of the alert processing based on highlighting of the driver's seat-side display 31 and recognition of the driver 101 on the object 150 has been described above, the same applies to the case of the passenger's seat-side display 32.

Next, the highlighting mode will be described. The controller 10 changes a display mode according to a degree of, for example, a collision probability of the detected object 150. Note that common components between the left and right configurations will be described as the door lining display 41, the roof display 42, and the glass display 43 by omitting L and R in the following description in some cases.

An alert level that indicates a level at which the driver 101 needs to be alerted to the presence, and a display mode associated with the alert level are set in advance to the controller 10. An example of the display mode will be described in a case where the alert level is an alert level 1 in a case where the own vehicle 100 and the object 150 are at a relatively separate distance, and is set to increase to an alert level 2 and an alert level 3 as the distance becomes shorter.

First, an example in which the display range of the driver's seat-side display 31 or the passenger's seat-side display 32 is changed will be described. The controller 10 causes only the door lining display 41 to display a signal at the alert level 1, causes both of the door lining display 41 and the roof display 42 to display signals at the alert level 2, and causes all the door lining display 41, the roof display 42, and the glass display 43 at the alert level 3 to display signals. By enlarging the display range according to a level of a risk, it is possible to alert the driver 101 to the presence of the object 150by the display mode.

Furthermore, the door lining display 41 and the roof display 42 can perform highlighting by changing how display is performed. It is also possible to perform alerting processing in a mode that calls for more attention to the driver 101 than that of normal display based on an area, a brightness, a chorma, a luminance, a flashing cycle of a signal, or a combination thereof displayed on the door lining display 41 and the roof display 42.

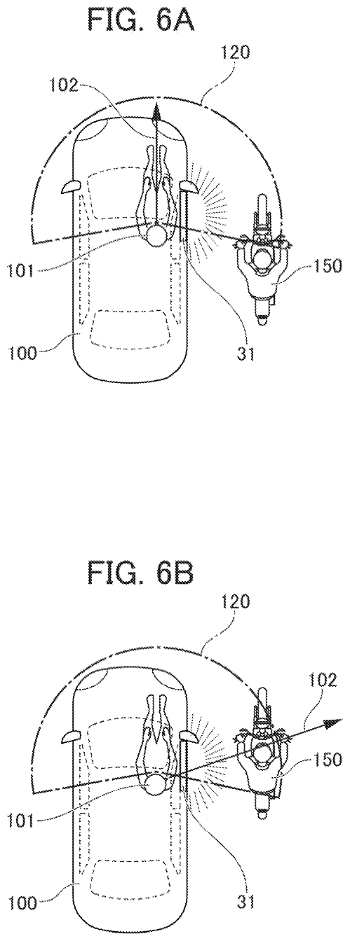

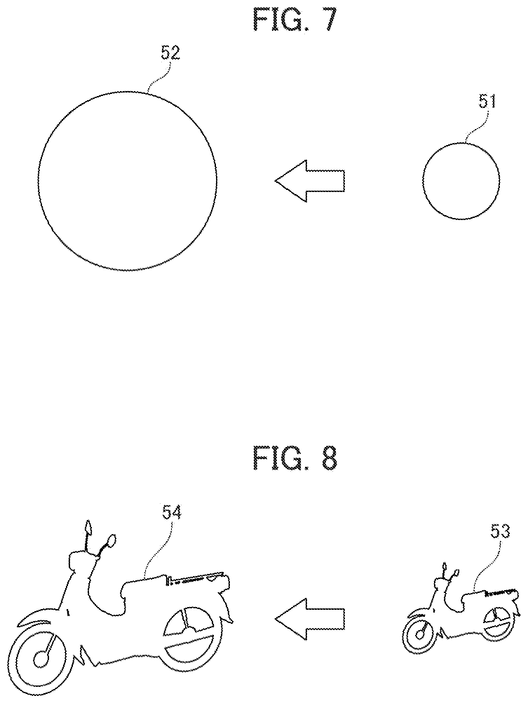

Next, an example in which display contents is changed according to the alert level will be described with reference to FIGS. 7 and 8. FIGS. 7 and 8 each schematically illustrate changes in display contents displayed on the glass display 43.

FIG. 7 is a view for illustrating an example in which a symbol as a signal is changed according to the alert level of the safety assist device 1 according to the present embodiment. In the example in FIG. 7, a small symbol 51 displayed in a case where the alert level is relatively low, and a large symbol 52 displayed in a case where the alert level is relatively high are illustrated. When, for example, a distance between the own vehicle 100 and the object 150 is long at a time of detection, and a risk is low, the small symbol 51 is displayed on the glass display 43, and, when the distance between the own vehicle 100 and the object 150 shortens, the display mode is changed from the small symbol 51 to the large symbol 52.

FIG. 8 is a view for illustrating an example in which a silhouette shape as a signal is changed according to the alert level of the safety assist device 1 according to the present embodiment. In the example in FIG. 8, a small silhouette 53 displayed in a case where the alert level is relatively low, and a large silhouette 54 displayed in a case where the alert level is relatively high are illustrated. When, for example, a distance between the own vehicle 100 and the object 150 is long at a time of detection, and a risk is low, the small silhouette 53 is displayed on the glass display 43, and, when the distance between the own vehicle 100 and the object 150 shortens, the display mode is changed from the small silhouette 53 to the large silhouette 54. Note that the symbols in FIG. 7 and the silhouette shapes in FIG. 8 may be displayed on the door lining display 41 or the roof display 42. Alternatively, one large signal may be displayed across the door lining display 41, the roof display 42, and the glass display 43.

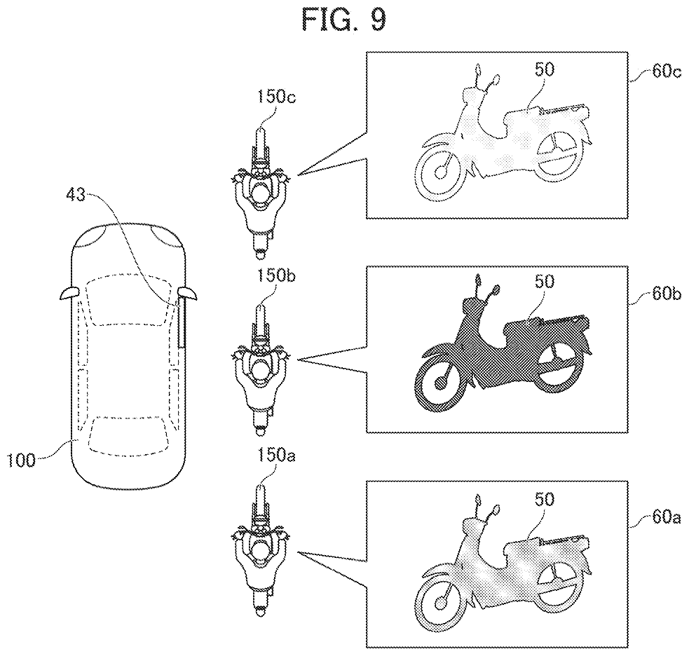

Furthermore, it is possible to not only change a silhouette size but also change shadings of a silhouette color according to the positional relationship between the own vehicle 100 and the object 150 and the degree of a risk. Next, an example in which the shadings of the silhouette color are changed according to the risk based on the positional relationship between the own vehicle 100 and the object 150 will be described with reference to FIG. 9. FIG. 9 is a view for illustrating fade-in processing and fade-out processing of the safety assist device 1 according to the present embodiment.

FIG. 9 illustrates an object 150a located on a rear right side seen from the own vehicle 100, an object 150b located on a lateral side of the own vehicle 100, and an object 150c located on a front right side of the own vehicle 100. In an example in FIG. 9, as the positional relationship with the own vehicle 100 changes from the object 150a to the object 150b, and the relative distance becomes shorter, an image that is subjected to the fade-in processing to gradually transition from an image 60a to an image 60b is displayed. As the positional relationship with the own vehicle 100 changes from the object 150b to the object 150c, and the relative distance becomes long, an image that is subjected to the fade-out processing to gradually transition from an image 60b to an image 60c is displayed. The object 150c is already at a position at which the driver 101 can visually check the object 150c, and therefore even in a case of the same relative distance, the fade-in processing performed when the relative distance becomes shorter is finished earlier than the fade-out processing performed when the relative distance becomes long.

Since the object 150b among these objects is the closest to the own vehicle 100, the risk is high, and therefore an alert level is the highest, the driver's seat-side display 31 displays the silhouette 50 having a dark color and a clear shape as shown in the image 60b. Since the object 150a is located on the rear right side of the own vehicle 100, and an alert level is lower than that of the object 150b, the driver's seat-side display 31 displays the silhouette 50 having a lighter color and shape as shown in the image 60a than those shown in the image 60b. Since the object 150c is located on the front right side of the own vehicle 100, and is at a position at which the driver 101 can visually check the object 150c, an alert level is also low, and the silhouette 50 having a much lighter color and shape as shown in the image 60c than those shown in the image 60a is displayed. Consequently, the display mode is changed based on the relative distances between the own vehicle 100 and the objects 150a to 150c, so that the driver 101 can visually perceivably grasp the degree of a risk.

Furthermore, the controller 10 can change the display mode based on the recognition level evaluated according to a sight line direction and a behavior of the driver 101. The recognition level is obtained from the detection information based on image analysis of the monitor camera 24, and the detection information of the object detection camera 21 and the radar 22 as the object detectors. For example, recognition levels are classified into five levels of a recognition level 1 to a recognition level 5, and the display mode is changed per recognition level.

The recognition level 1 indicates a state where the driver 101 does not recognize the object 150, and does not pay attention to surroundings. The recognition level 2 indicates a state where, even if the driver 101 does not recognize the object 150, the sight line direction checks the surroundings (peripheral visual field recognition) and pays attention to the surroundings. The recognition level 3 indicates a state where the sight line direction of the driver 101 can recognize display of one of the driver's seat-side display 31 and the passenger's seat-side display 32 in which the object 150 is present. For example, which one of left and right directions the driver 101 faces, is determined based on a motion of a scenery followed by the sight line direction of the driver 101, and in a case of a state where a direction that the driver 101 faces is the same as a direction in which the object 150 is present, the recognition level 3 is determined. The recognition level 4 indicates a state where the driver 101 directly views a mirror on a side on which the object 150 is present. In a case where, for example, the sight line direction of the driver 101 greatly moves, and the sight line direction faces the mirror on the side on which the object 150 is present or surroundings therearound, the recognition level 4 is determined. The recognition level 5 indicates a state where the driver 101 recognizes the presence of the object 150. In a case where, for example, the sight line direction of the driver 101 stays at a certain place, and directly views the object 150 via the mirror, the recognition level 5 is determined.

The controller 10 performs control for performing highlighting for calling for attention when the obtained recognition level is low, and weakening display when the recognition level is high. For example, the color and the shape are made clear when the recognition level is low, and the color and the shape are made light when the recognition level is high. The controller 10 performs control for gradually blurring the color and the shape like fade-out in a case where the recognition level changes from a low state to a high state.

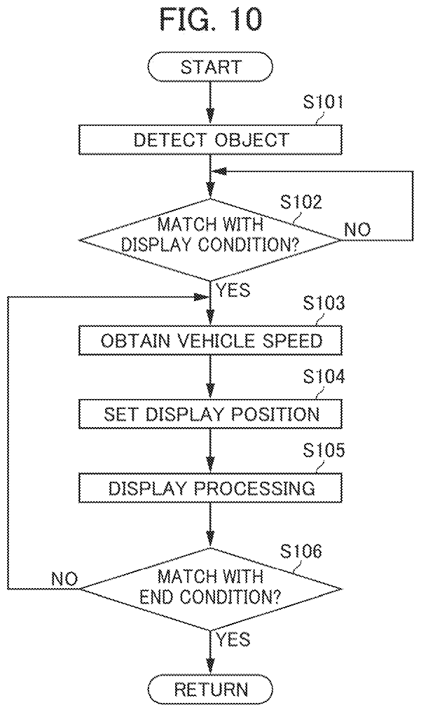

Next, an entire flow of the alert processing will be described with reference to FIG. 10. FIG. 10 is a flowchart illustrating a flow of the alert processing of the safety assist device 1 according to the present embodiment. Note that the flowchart described below is merely an example, and processing contents and a processing order of the flowchart can be changed as appropriate.

First, the controller 10 executes processing of detecting the object 150 outside the own vehicle 100 by the object detection camera 21, the radar 22, or both (step S101). Next, the controller 10 determines whether or not detection information from the object detection camera 21, the radar 22, or both matches with a display condition of the driver's seat-side display 31 or the passenger's seat-side display 32 (step S102).

The display condition is set based on whether or not the position of the object 150 with respect to the own vehicle 100 has a risk to which the driver 101 needs to be alerted. When, for example, it is determined that there is the risk to which the driver 101 needs to be alerted based on a relative distance, a relative speed, and a movement direction of the object 150 with respect to the own vehicle 100, and a decision criterion set in advance, it is determined that the detection information has matched with the display condition.

When determining in step S102 that there is no risk for which an alert needs to be raised and the detection information does not match with the display condition, the controller 10 continues the processing of detecting the object 150 (step S102; No). When determining in step S102 that there is the risk for which an alert needs to be raised, and the detection information matches with the display condition, the controller 10 moves processing to step S103 (step S102; Yes).

In step S103, the controller 10 obtains a vehicle speed of the own vehicle 100 from the detection information of the vehicle speed sensor 23, and moves the processing to step S104 (Step S103).

In step S104, the controller 10 executes processing of determining a display position based on the vehicle speed of the own vehicle 100 and a positional relationship of the object 150 with respect to the own vehicle 100 (step S104). For example, the controller 10 determines whether the object 150 is located on the driver's seat-side or the passenger's seat-side of the own vehicle 100 based on the detection information of the object detection camera 21 and the radar 22, and determines the display position in the front/rear direction of the driver's seat-side display 31 or the passenger's seat-side display 32 based on the vehicle speed. As described above, as the vehicle speed is faster, the display position is set closer to the front side.

Next, the controller 10 sets a display mode that is displayed at the display position, and executes display processing of displaying the display mode (step S105). As described above, in this display mode, fade-in or fade-out processing set according to the alert level or the recognition level of the driver 101 based on a collision risk of the own vehicle 100 and the object 150 are also performed. Furthermore, in this display mode, processing of changing the display position following movement of the object 150 is also performed. Furthermore, the controller 10 moves the processing to step S106.

Next, whether or not a display processing end condition has been satisfied is determined (step S106). As the display processing end condition, a condition for finishing the display processing as appropriate such as a case where the object 150 that has caused output of display stops being detected by the object detection camera 21 or the radar 22, a case where a predetermined time has passed, or a case where fade-out processing has been executed can be set. When the end condition is not satisfied, the controller 10 returns the processing to step S103, and repeats the processing of moving the processing to step S103 (step S106; No). When the end condition is satisfied, the controller 10 stops the display processing, and returns the processing to step S101 (step S106; Yes).

The above-described safety assist device 1 according to the present embodiment includes the object detection camera 21 or/and the radar 22 as the object detectors that detect at least the presence of the object 150 and the position of the object 150 on a lateral side or a rear side of the own vehicle 100, the vehicle speed sensor 23 as the vehicle speed detector that detects the vehicle speed of the own vehicle 100, the driver's seat-side display 31 and the passenger's seat-side display 32 that are provided at least on the lateral side of the driver's seat 91 inside the own vehicle 100, and the controller 10 that causes the driver's seat-side display 31 and the passenger's seat-side display 32 to display a signal in response to the presence of the object detected by the object detection camera 21, the radar 22, and the like. The controller 10 moves a position at which the signal is displayed toward the front side in the display range of the driver's seat-side display 31 and the passenger's seat-side display 32 in accordance with an increase in the vehicle speed detected by the vehicle speed sensor 23.

Consequently, even when the own vehicle 100 travels at a high speed at which the visual field of the driver 101 tends to be narrow, an indication of the presence of the object 150 is displayed on the front side that readily comes into a view of the driver 101 according to the vehicle speed, so that it is possible to perceivably alert the driver to the presence of the object 150.

Furthermore, according to the present embodiment, the driver's seat-side display 31 disposed on the driver's seat 91 side and the passenger's seat-side display 32 disposed on the passenger's seat 92 side are provided, and one of the driver's seat-side display 31 and the passenger's seat-side display 32 that corresponds to a direction in which the object 150 is present in a vehicle width direction with respect to the own vehicle 100 is caused to display the signal.

Consequently, one of the driver's seat-side display 31 and the passenger's seat-side display 32 that corresponds to the position of the object 150 displays the signal, so that it is possible to make the driver 101 intuitively recognize the presence of the object 150 somewhere in the vehicle width direction.

Furthermore, according to the present embodiment, the signal is displayed such that in a case where the own vehicle is traveling at a predetermined vehicle speed, an angle formed between a direction of a sight line 81R, 82R, 83R of the driver 101 seeing a position on the driver's seat-side display 31 at which the signal is displayable and a direction of a sight line of the driver facing a front is substantially equal to an angle formed between a direction of a sight line 81L, 82L, 83L of the driver 101 seeing a position on the passenger's seat-side display 32 at which the signal is displayable and the direction of the sight line of the driver 101 facing the front.

Consequently, both of the driver's seat-side display 31 and the passenger's seat-side display 32 can make the signal come into the driver's visual field range, so that it is possible to further enhance visibility.

Furthermore, according to the present embodiment, the object detection camera 21 or/and the radar 22 further detect a relative distance between the own vehicle 100 and the object 150, and the controller 10 changes an intensity of the signal according to the relative distance.

Consequently, the driver 101 can grasp not only a risk of collision against the object 150, but also a level of the risk.

Furthermore, according to the present embodiment, the intensity is an area of the signal, a luminance of the signal, a chroma of the signal, a brightness of the signal, a flashing cycle of the signal, or a combination thereof.

Consequently, it is possible to make the driver more intuitively recognize the level of the risk.

According to the present embodiment, the object detection camera 21 or/and the radar 22 further detect the relative positions of the own vehicle 100 and the object 150, and the position at which the signal is displayed changes according to the relative positions.

Consequently, it is also possible to recognize the position of the object 150, based on a change in the display position of the signal. Furthermore, since it is possible to recognize the relative distance based on the intensity of the signal, and it is possible to distinguish whether the object 150 has approached so that the position of the signal has changed, or the vehicle speed of the own vehicle has increased so that the position of the signal has changed.

Furthermore, according to the present embodiment, the door lining display 41 and the roof display 42 as the displays are provided adjacent to the door glass 111 of the front door 110.

Consequently, it is possible to display the signal at the position at which the driver 101 easily perceives the signal.

Furthermore, according to the present embodiment, the glass display 43 as the display is provided to the door glass 111 of the front door 110.

Consequently, it is possible to check the signal in a peripheral visual field area where sight line movement is little, and make the driver 101 more perceivably recognize the presence of the object 150.

Furthermore, according to the present embodiment, the safety assist device 1 further includes the monitor camera 24 as the sight line monitor that monitors a sight line of the driver 101, and the controller 10 lowers an intensity of the signal upon determining, based on detection information from the monitor camera 24, that the driver 101 has visually recognized the object 150.

Consequently, it is not necessary to present the presence of the object 150 to the driver 101 when the driver 101 recognizes the object 150, so that a less necessary signal for the driver 101 is prevented from being displayed, and it is possible to reduce annoyance.

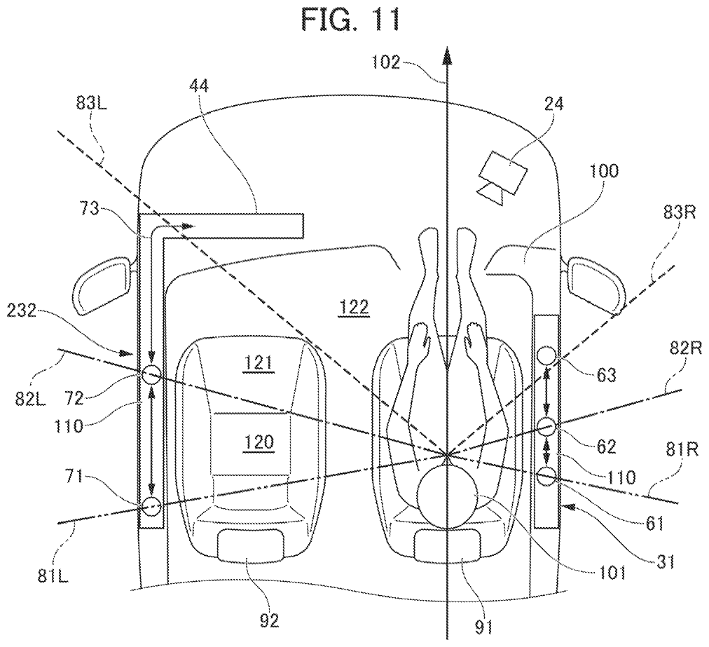

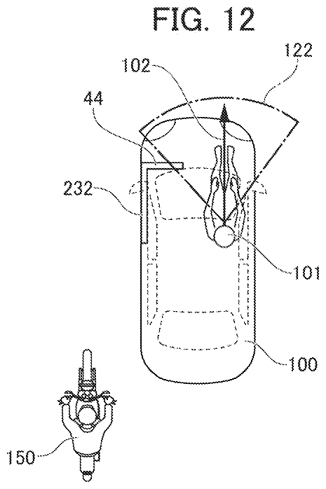

The embodiment of the present invention has been described above. However, the present invention is not limited to the embodiment. For example, the above embodiment employs the configuration where the driver's seat-side display 31 is located on the right side of the driver's seat 91, and the passenger's seat-side display 32 is located on the left side of the passenger's seat 92. However, this configuration can be changed as illustrated in FIGS. 11 and 12. FIG. 11 is a view illustrating a relationship between a display position at which information indicating the object 150 is displayed and a visual field range of the driver 101 that changes depending on a vehicle speed, according to the safety assist device 1 according to a modification. FIG. 12 is a view for illustrating an example in which an indication of the presence of the object 150 is displayed on a passenger's seat-side display 232 of the safety assist device 1 according to the modification. Note that common and similar components to those of the above embodiment will be assigned the same reference numerals, and detailed description thereof will be omitted in some cases.

The passenger's seat-side display 232 according to the modification employs a different configuration from that of the passenger's seat-side display 32 according to the above embodiment in that the passenger's seat-side display 232 includes a dashboard display 44 that extends in the vehicle width direction. The dashboard display 44 extends from the passenger's seat 92 side to the driver's seat 91 side in the vehicle width direction such that a right end part of the dashboard display 44 overlaps the visual field range 122 in the high-speed range. The dashboard display 44 is disposed on an interior panel of a dashboard in front of the passenger's seat 92. The dashboard display 44 may be configured by extending the door lining display 41L, or may be configured independently from the door lining display 41L.

A display position 73 of the dashboard display 44 is set on a virtual straight line inclined at a predetermined angle (angle-α) leftward from the front sight line direction 102 that serves 0 degree of a reference angle. In this example, the display position 73 is set to a position that crosses a straight line inclined at −40 degrees from the front sight line direction. Furthermore, an angle formed between the front right sight line 83R that views the display position 73 with the position of the driver 101 serving as the position reference, and the front sight line direction 102 is 40 degrees, and an angle formed between the front left sight line 83L that views the display position 73 with the position of the driver 101 serving as the position reference, and the front sight line direction 102 is also 40 degrees. In the example in FIG. 12, the vehicle speed of the own vehicle 100 is fast, and therefore the visual field range 122 of the driver 101 is narrowed, and it is difficult to check display on the left side. However, the configuration according to this modification can display a signal that alerts the driver 101 to the presence of the object 150 at a position at which the driver 101 easily visually recognizes the presence of the object 150 even when such a speed range is a higher speed range and the visual field range 122 is narrower.

Furthermore, the above embodiment has been described with reference to the example in which levels are classified into, for example, the alert levels and recognition levels to change the display mode. However, it is also possible to omit the processing of changing the display mode.

In addition, the components according to the above embodiment can be replaced with known components as appropriate without departing from the spirit of the present invention, and the above modification may be combined as appropriate.

### EXPLANATION OF REFERENCE NUMERALS

1: Safety assist device
10: Controller
21: Object detection camera (object detector)
22: Radar (object detector)
23: Vehicle speed sensor (vehicle speed detector)
24: Monitor camera (sight line monitor)
31: Driver's seat-side display (display)
32: Passenger's seat-side display (display)
91: Driver's seat
92: Passenger's seat
100: Own vehicle
150: Object

What is claimed is:

1. A safety assist device for a vehicle, the safety assist device comprising:
an object detector that detects at least presence of an object and a position of the object on a lateral side or a rear side of an own vehicle;
a vehicle speed detector that detects a vehicle speed of the own vehicle;
a display that is provided at least on a lateral side of a driver's seat inside the own vehicle; and
a controller that causes the display to display a signal in response to the presence of the object detected by the object detector, wherein
the controller moves a position at which the signal is displayed toward a front side in a display range of the display in accordance with an increase in the vehicle speed detected by the vehicle speed detector.

2. The safety assist device according to claim 1, wherein
a driver's seat-side display disposed on a side of the driver's seat and a passenger's seat-side display disposed on a side of a passenger's seat are provided as the display, and
one of the driver's seat-side display and the passenger's seat-side display that corresponds to a direction in which the object is present in a vehicle width direction with respect to the own vehicle is caused to display the signal.

3. The safety assist device according to claim 2, wherein
the signal is displayed such that in a case where the own vehicle is traveling at a predetermined vehicle speed, an angle formed between a direction of a sight line of a driver seeing a position on the driver's seat-side display at which the signal is displayable and a direction of a sight line of the driver facing a front is substantially equal to an angle formed between a direction of a sight line of the driver seeing a position on the passenger's seat-side display at which the signal is displayable and the direction of the sight line of the driver facing the front.

4. The safety assist device according to claim 1, wherein
the object detector further detects a relative distance between the own vehicle and the object, and
the controller changes an intensity of the signal according to the relative distance.

5. The safety assist device according to claim 4, wherein
the intensity is an area of the signal, a luminance of the signal, a chroma of the signal, a brightness of the signal, a flashing cycle of the signal, or a combination thereof.

6. The safety assist device according to claim 5, wherein
the object detector further detects relative positions of the own vehicle and the object, and
the position at which the signal is displayed changes according to the relative positions.

7. The safety assist device according to claim 1, wherein the display is provided adjacent to a door glass of a front door.

8. The safety assist device according to claim 1, wherein the display is provided to the door glass of the front door.

9. The safety assist device according to claim 1, further comprising a sight line monitor that monitors a sight line of a driver,
the controller lowers an intensity of the signal upon determining, based on detection information from the sight line monitor, that the driver has visually recognized the object.
